(19) United States
(12) Patent Application Publication
(10) Pub. No.: US 2005/0226334 A1
(43) Pub. Date: Oct. 13, 2005

(54) Method and apparatus for implementing motion scalability

(75) Inventor: Woo-Jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/101,579

(22) Filed: Apr. 8, 2005

Related U.S. Application Data
(60) Provisional application No. 60/560,250, filed on Apr. 8, 2004.

(30) Foreign Application Priority Data
May 7, 2004 (KR) 10-2004-0032237

(51) Int. Cl. H04N 7/12

(52) U.S. Cl. 375/240.16; 375/240.1; 375/240.24; 375/240.03

(57) ABSTRACT

An apparatus and method for improving the multi-layered motion vector compression efficiency of a video coding method by efficiently predicting a motion vector in an enhancement layer from a motion vector in a base layer. The apparatus includes a base layer determining module that determines motion vector component of a base layer having the base layer pixel accuracy using the obtained motion vector, and an enhancement layer determining module that determines a motion vector component of an enhancement layer having the enhancement layer pixel accuracy which is obtained motion vector.

### CROSS-REFERENCE TO RELATED APPLICATIONS

This application claims priority from Korean Patent Application No. 10-2004-0032237 filed on May 7, 2004, in the Korean Intellectual Property Office, and U.S. Provisional Patent Application No. 60/560,250 filed on Apr. 8, 2004, in the United States Patent and Trademark Office, the disclosures of which are incorporated herein by reference in their entirety.

### BACKGROUND OF THE INVENTION

1. Field of the Invention

The present invention relates to a video compression method, and more particularly, to an apparatus and a method for improving the compression efficiency of a motion vector by efficiently predicting a motion vector in an enhancement layer from a motion vector in a base layer, in a video coding method using a multilayer structure.

2. Description of the Related Art

The development of information technology (IT) such as the Internet has increased text, voice and video communication. Conventional text communication cannot satisfy the various demands of users, and thus multimedia services that can provide various types of information such as text, pictures, and music have increased. Multimedia data requires a large capacity storage medium and a wide bandwidth for transmission since the size of multimedia data is usually large. Accordingly, a compression coding method for transmitting multimedia that includes text, video, and audio is necessary.

A basic principle of data compression is removing data redundancy. Data can be compressed by removing spatial redundancy where the same color or object is repeated in an image, or by removing temporal redundancy where there is little change between adjacent frames in a moving image or the same sound is repeated in audio, or by removing visual redundancy taking into account human eyesight and limited perception of high frequency.

Currently, most video coding standards are based on a motion compensation estimation coding method. Temporal redundancy is usually removed by temporal filtering based on motion compensation, and spatial redundancy is usually removed by spatial transform.

To transmit multimedia created after removing data redundancy, transmission media are necessary. Different types of transmission media for multimedia have different performance. Currently used transmission media have various transmission rates. For example, an ultrahigh-speed communication network can transmit data at a rate of several megabits per second while a mobile communication network has a transmission rate of 384 kilobits per second.

Accordingly, to support transmission media having various speeds or to transmit multimedia data at a rate suitable to a transmission environment, data coding methods having scalability, such as wavelet video coding and subband video coding, may be suitable to a multimedia environment.

Scalability refers to the ability to partially decode a single compressed bitstream at a decoder or a pre-decoder part. The decoder or pre-decoder can reconstruct multimedia sequences having different quality levels, resolutions, or frame rates from only some of the bitstreams coded by a scalable coding method.

In a conventional video coding technique, a bitstream typically consists of motion information (motion vector, block size, etc.) and texture information corresponding to a residual obtained after motion estimation.

In a conventional method for achieving texture scalability, wavelet transform and embedded quantization are used to implement spatial scalability and Motion Compensated Temporal Filtering is used to provide temporal scalability.

Another method for implementing texture scalability is to temporally or spatially construct texture information into multiple layers. For example, the texture information consists of multiple layers: i.e., a base layer, a first enhancement layer, and a second enhancement layer. To support spatial scalability, the respective layers have different resolution levels: i.e., Quarter Common Intermediate Format (QCIF), Common Intermediate Format (CIF), and 2CIF. Signal-to-noise ratio (SNR) and temporal scalabilities are implemented within each layer.

In existing video coding schemes, motion information is usually compressed losslessly as a whole. However, the non-scalable motion information can significantly degrade the coding efficiency due to an excessive amount of motion information, especially for a bitstream compressed at low bitrates. In order to solve this problem, research is being actively conducted to implement motion scalability. A method to support motion scalability is to divide motion information into layers according to relative significance and to transmit only part of the motion information for low bitrates with loss, giving more bits to textures. Motion scalability is an issue of great concern to MPEG-21 PART 13 scalable video coding.

Recently, various approaches have been proposed for implementing motion scalability by constructing a motion vector into multiple layers. The approaches are divided into two categories: a partition-based approach and an accuracy-based approach.

The partitioned-based approach generates a multi-layered motion vector by obtaining motion vectors for various resolutions in a frame with the same pixel accuracy. The accuracy-based approach generates a multi-layered motion vector by obtaining motion vectors for various pixel accuracies in a frame having one resolution.

The present invention proposes a method for implementing motion scalability by reconstructing a motion vector into multiple layers using the pixel accuracy-based approach. This method is focused on providing high coding performance for a base layer and an enhancement layer simultaneously.

### SUMMARY OF THE INVENTION

The present invention provides a method for efficiently implementing motion scalability using a motion vector consisting of multiple layers.

The present invention also provides a method for improving coding efficiency when using only a base layer at a low bitrate by constructing a motion vector into layers according to the pixel accuracy in such a way as to minimize distortion.

The present invention also provides a method for improving coding performance by minimizing overhead when using all layers at a high bitrate.

According to an aspect of the present invention, there is provided an apparatus for reconstructing a motion vector obtained at the predetermined pixel accuracy including a base layer determining module determining a motion vector component of a base layer using the obtained motion vector according to the pixel accuracy of the base layer, and an enhancement layer determining module determining a motion vector component of an enhancement layer that is close to the obtained motion vector according to the pixel accuracy of the enhancement layer.

The base layer determining module may determine the motion vector component of the base layer that is close to a value predicted from motion vectors of neighboring blocks according to the pixel accuracy of the base layer.

In order to determine the motion vector component of the base layer according to the pixel accuracy of the base layer, the base layer determining module may separate the obtained motion vector into a sign and a magnitude, may use an unsigned value to represent the magnitude of the motion vector, and may attach the original sign to the value.

The base layer determining module may determine a value closest to the obtained motion vector as the motion vector component of the base layer according to the pixel accuracy of the base layer.

The motion vector component x_{b} of the base layer may be determined using x_{b}=sign(x)└|x|+0.5┘ where sign(x) denotes a signal function that returns values of 1 and −1 when x is a positive value and a negative value, respectively, |x| denotes an absolute value function with respect to variable x, and └|x|+0.5┘ denotes a function giving the largest integer not exceeding |x|+0.5 by stripping the decimal part.

The apparatus for reconstructing a motion vector obtained at a predetermined pixel accuracy may further include a first compression module removing redundancy in a motion vector component of a first enhancement layer among the enhancement layers using the fact that the motion vector component of the first enhancement layer has an opposite sign to the motion vector component of the base layer when the motion vector component of the first enhancement layer is not 0.

The apparatus for reconstructing a motion vector obtained at the predetermined pixel accuracy may further include a second compression module removing redundancy in a motion vector component of a second enhancement layer using the fact that the motion vector component of the second enhancement layer is always 0 when the motion vector component of the first enhancement layer is not 0.

According to another aspect of the present invention, there is provided a video encoder using a motion vector consisting of multiple layers, the encoder including a motion vector reconstruction module including a motion vector search module obtaining a motion vector with the predetermined pixel accuracy, a base layer determining module determining a motion vector component of a base layer using the obtained motion vector according to the pixel accuracy of the base layer, an enhancement layer determining module determining a motion vector component of an enhancement layer that is close to the obtained motion vector according to the pixel accuracy of the enhancement layer, a temporal filtering module removing temporal redundancies by filtering frames in a direction of a temporal axis using the obtained motion vectors, a spatial transform module removing spatial redundancies from the frames from which the temporal redundancies have been removed and creating transform coefficients, and a quantization module performing quantization on the transform coefficients.

According to still another aspect of the present invention, there is provided an apparatus for reconstructing a motion vector consisting of a base layer and at least one enhancement layer, the apparatus including a layer reconstruction module reconstructing motion vector components of the respective layers from corresponding values of the layers interpreted from an input bitstream, and a motion addition module adding the reconstructed motion vector components of the layers together and providing the motion vector.

According to yet another aspect of the present invention, there is provided an apparatus for reconstructing a motion vector consisting of a base layer and at least one enhancement layer, the apparatus including a first reconstruction module reconstructing a motion vector component of a first enhancement layer by attaching a sign to a value of the first enhancement layer interpreted from an input bitstream, which is opposite to the sign of a corresponding value of the base layer, a layer reconstruction module reconstructing motion vector components of the base layer and at least one enhancement layer other than the first enhancement layer from values of the base layer and the at least one enhancement layer interpreted from the input bitstream, and a motion addition module adding the reconstructed motion vector components of the layers together and providing the motion vector.

According to a further aspect of the present invention, there is provided an apparatus for reconstructing a motion vector consisting of a base layer and at least one enhancement layer, the apparatus including a first reconstruction module reconstructing a motion vector component of a first enhancement layer by attaching a sign to a value of the first enhancement layer interpreted from an input bitstream, which is opposite to the sign of a corresponding value of the base layer, a second reconstruction module setting a motion vector component of a second enhancement layer to 0 when the value of the first enhancement layer is not 0 and reconstructing the motion vector component of the second enhancement layer from a value of the second enhancement layer interpreted from the input bitstream when the value of the first enhancement layer is 0, a layer reconstruction module reconstructing motion vector components of the base layer and at least one enhancement layer other than the first and second enhancement layers from values of the base layer and the at least one enhancement layer interpreted from the input bitstream, and a motion addition module adding the reconstructed motion vector components of the layers together and providing the motion vector.

According to another aspect of the present invention, there is provided a video decoder using a motion vector consisting of multiple layers, the decoder including an entropy decoding module interpreting an input bitstream and extracting texture information and motion information from the bitstream, a motion vector reconstruction module reconstructing motion vector component of the respective layers from corresponding values of the layers contained in the extracted motion information and providing the motion vector after adding the motion vector components of the respective layers together, an inverse quantization module applying inverse quantization to the texture information and outputting transform coefficients, an inverse spatial transform module inversely transforming the transform coefficients into transform coefficients in a spatial domain by performing the inverse of spatial transform, and an inverse temporal filtering module performing inverse temporal filtering on the transform coefficients in the spatial domain using the obtained motion vector and reconstructing frames in a video sequence.

The motion vector reconstruction module may include a first reconstruction module reconstructing a motion vector component of a first enhancement layer by attaching a sign to a value of the first enhancement layer contained in the motion information, which is opposite to the sign of a corresponding value of the base layer, a layer reconstruction module reconstructing motion vector components of the base layer and at least one enhancement layer other than the first enhancement layer from values of the base layer and the at least one enhancement layer, and a motion addition module adding the reconstructed motion vector components of the layers together and providing the motion vector.

In addition, the motion vector reconstruction module may include a first reconstruction module reconstructing a motion vector component of a first enhancement layer by attaching a sign to a value of the first enhancement layer contained in the motion information, which is opposite to the sign of a corresponding value of the base layer, a second reconstruction module setting a motion vector component of a second enhancement layer to 0 when the value of the first enhancement layer is not 0 and reconstructing the motion vector component of the second enhancement layer from a value of the second enhancement layer contained in the motion information when the value of the first enhancement layer is 0, a layer reconstruction module reconstructing motion vector components of the base layer and at least one enhancement layer other than the first and second enhancement layers from values of the base layer and the at least one enhancement layer contained in the motion information, and a motion addition module adding the reconstructed motion vector components of the layers together and providing the motion vector.

According to still another aspect of the present invention, there is provided a method for reconstructing a motion vector obtained at the predetermined pixel accuracy, the method including determining a motion vector component of a base layer using the obtained motion vector according to the pixel accuracy of the base layer, and determining a motion vector component of an enhancement layer that is close to the obtained motion vector according to the pixel accuracy of the enhancement layer.

In the determining of the motion vector component of the base layer, the motion vector component of the base layer may be determined to be close to a value predicted from motion vectors of neighboring blocks according to the pixel accuracy of the base layer.

In the determining of the motion vector component of the base layer, the motion vector component of the base layer may be determined according to the pixel accuracy of the base layer by separating the obtained motion vector into a sign and a magnitude, using an unsigned value to represent the magnitude of the motion vector, and attaching the original sign to the value.

In the determining of the motion vector component of the base layer, a value closest to the obtained motion vector may be determined as the motion vector component of the base layer according to the pixel accuracy of the base layer.

According to yet another aspect of the present invention, there is provided a method for reconstructing a motion vector consisting of a base layer and at least one enhancement layer, the method including reconstructing motion vector components of the respective layers from corresponding values of the layers interpreted from an input bitstream, and adding the reconstructed motion vector components of the layers together and providing the motion vector.

According to a further aspect of the present invention, there is provided a method for reconstructing a motion vector consisting of a base layer and at least one enhancement layer, the method including reconstructing a motion vector component of a first enhancement layer by attaching a sign to a value of the first enhancement layer interpreted from an input bitstream, which is opposite to the sign of a corresponding value of the base layer, reconstructing motion vector components of the base layer and at least one enhancement layer other than the first enhancement layer from values of the base layer and the at least one enhancement layer interpreted from the input bitstream, and adding the reconstructed motion vector components of the layers together and providing the motion vector.

According to still another aspect of the present invention, there is provided a method for reconstructing a motion vector consisting of a base layer and at least one enhancement layer, the method including reconstructing a motion vector component of a first enhancement layer by attaching a sign to a value of the first enhancement layer interpreted from an input bitstream, which is opposite to the sign of a corresponding value of the base layer, setting a motion vector component of a second enhancement layer to 0 when the value of the first enhancement layer is not 0 and reconstructing the motion vector component of the second enhancement layer from a value of the second enhancement layer interpreted from the input bitstream when the value of the first enhancement layer is 0, reconstructing motion vector components of the base layer and at least one enhancement layer other than the first and second enhancement layers from values of the base layer and the at least one enhancement layer interpreted from the input bitstream, and adding the reconstructed motion vector components of the layers together and providing the motion vector.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for explaining a method of reconstructing a multi-layered motion vector according to the pixel accuracy;

FIG. 2 illustrates a method for improving the compression efficiency of a motion vector according to a first embodiment of the present invention;

FIG. 3 illustrates an example of obtaining a predicted value for a current block by correlation with neighboring blocks;

FIG. 4 illustrates a third embodiment of the present invention;

FIG. 5 is a graph illustrating the results of measuring peak signal-to-noise ratios (PSNRs) as a video quality indicator using motion vectors according to the first through third embodiments of the present invention.

FIG. 6A is a graph illustrating the results of measuring a PSNR when compressing a Foreman CIF sequence at 100 Kbps according to the third embodiment of the present invention;

FIG. 6B is a graph comparing the experimental results of the third embodiment of FIG. 6A and the fourth embodiment of the present invention;

FIG. 7 is a block diagram of a video coding system;

FIG. 8 is a block diagram of a video encoder;

FIG. 9 is a block diagram of an exemplary motion vector reconstruction module according to the first embodiment of the present invention;

FIG. 10 is an illustration for explaining a process of obtaining a motion vector of an enhancement layer;

FIG. 11 is a block diagram of another exemplary motion vector reconstruction module for implementing the method according to the fourth embodiment of the present invention;

FIG. 12 is a block diagram of a video decoder;

FIG. 13 is a block diagram of an exemplary motion vector reconstruction module according to the present invention;

FIG. 14 is a block diagram of another exemplary motion vector reconstruction module for implementing the method according to the fourth embodiment of the present invention;

FIG. 15 is a schematic diagram illustrating a bitstream structure;

FIG. 16 is a diagram illustrating the detailed structure of each group of pictures (GOP) field; and

FIG. 17 is a diagram illustrating the detailed structure of a motion vector (MV) field.

### DETAILED DESCRIPTION OF THE INVENTION

The present invention presents a method for constructing a base layer in such a way as to minimize distortion when only the base layer is used, and a method for quantizing an enhancement layer in such a way as to minimize overhead when all layers are used.

The present invention will now be described more fully with reference to the accompanying drawings, in which exemplary embodiments of this invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

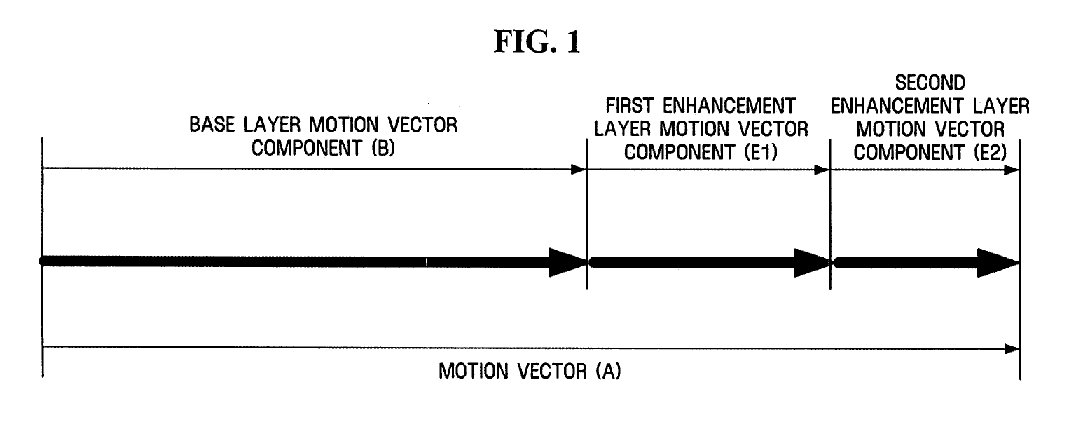

FIG. 1 shows an example in which one motion vector is divided into three motion vector components. Referring to FIG. 1, after finding a motion vector A with the predetermined pixel accuracy, the motion vector A is reconstructed as the sum of a base layer motion vector component B, a first enhancement layer motion vector component E1, and a second enhancement layer motion vector component E2. A motion vector obtained as a result of a motion vector search with the predetermined pixel accuracy as described above is defined as an “actual motion vector”.

Pixel accuracy used for the highest enhancement layer can be typically selected as the predetermined pixel accuracy. The motion vectors of the respective layers have different pixel accuracies that increase in an order from the lowest (close to a base layer) to the highest (away from the base layer). For example, the base layer has one pixel accuracy, the first enhancement layer has a half pixel accuracy, and the second enhancement layer has a quarter pixel accuracy.

An encoder transmits the reconstructed motion vector to a predecoder that truncates a part of the motion vector in an order from the highest to the lowest layers while a decoder receives the remaining part of the motion vector. By performing this process it is possible to implement scalability for a motion vector (motion scalability).

For example, an encoder may transmit motion vector components of all layers (the base layer, the first enhancement layer, and the second enhancement layer) while the predecoder may transmit only components of the base layer and the first enhancement layer to the decoder by truncating a component of the second enhancement layer when it determines according to available communication conditions that transmission of all the motion vector components is unsuitable. The decoder uses the components of the base layer and the first enhancement layer to reconstruct a motion vector.

The base layer is essential motion vector information having the highest priority and it cannot be omitted during transmission. Thus, a bitrate in the base layer must be equal to or less than the minimum bandwidth supported by a network. The bitrate in transmission of all the layers (the base layer and the first and second enhancement layers) must be equal to or less than the maximum bandwidth.

### Method for Constructing the Base Layer

The present invention proposes methods for constructing a base layer according to first through third embodiments and verifies the methods through experiments.

In each embodiment, a motion vector is constructed into multiple layers: a motion vector component of the base layer represented with integer-pixel accuracy, and motion vector components of enhancement layers respectively represented with half- and quarter-pixel accuracy.

The base layer uses an integer to represent a motion vector component, and the enhancement layers use a symbol of 1, −1, or 0 instead of a real number in order to represent motion vector components in a simple way. While a motion vector is usually represented by a pair of x, and y components, only one component will be described throughout this specification for clarity of explanation.

For example, while the motion vector component of the first enhancement layer with half pixel accuracy may have a value of −0.5, 0.5, or 0, it is represented by the symbol −1, 1, or 0. Similarly, when the motion vector component of the second enhancement layer with quarter pixel accuracy may have a value of −0.25, 0.25, or 0, it is represented by the symbol −1, 1, or 0.

Since a motion vector of the base layer is represented by an integer part, there is a close spatial correlation between motion vectors in the base layer. Thus, after considering this spatial correlation and obtaining a predicted value of a current block from the integer motion vectors of neighboring blocks, only a residual between an actual motion vector of the current block and the predicted value is encoded and transmitted. Conversely, the enhancement layers are usually encoded without considering neighboring blocks because there is little spatial correlation between motion vectors.

One of the most important goals in implementing motion scalability is to prevent significant degradation in coding performance when an enhancement layer is truncated. When the truncation of the enhancement layer increases a motion vector error, thereby significantly degrading the quality of the video reconstructed by a decoder, this will also reduce the effect of improving video quality by allocating more bits to texture information due to the reduction of motion vector bits. Therefore, the first through third embodiments of the present invention are focused on preventing a significant drop in the peak signal-to-noise ratio (PSNR) when only a base layer is used, compared to when a base layer and enhancement layers are used.

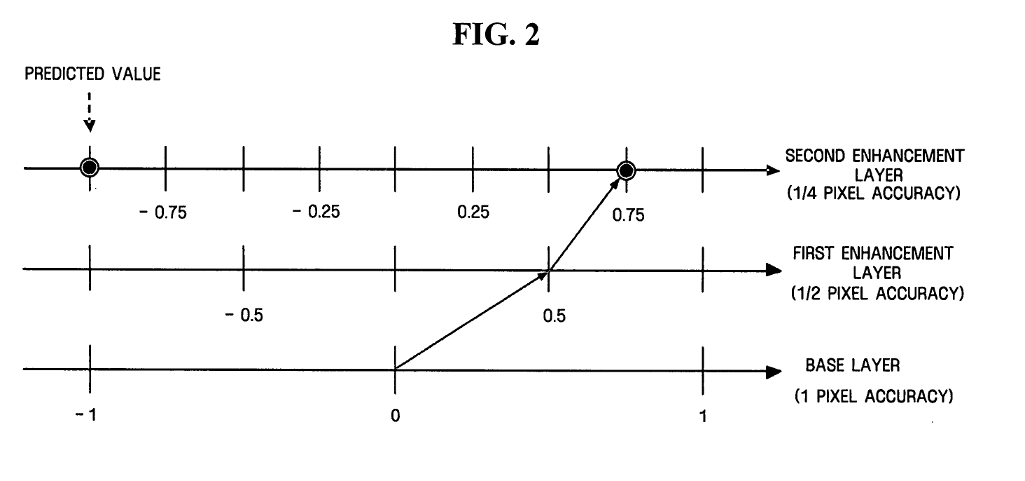

In a first embodiment of the present invention, a method for improving the compression efficiency of a motion vector using a spatial correlation of the base layer is proposed. According to the first embodiment, the decimal part of an actual value is rounded up or down so that the resultant value is closer to a value predicted from the motion vector components of the neighboring blocks in the base layer. FIG. 2 shows an example of predicting a motion vector in first and second enhancement layers from a motion vector in a base layer. Referring to FIG. 2, when a value predicted from neighboring blocks in the base layer is −1 and an actual motion vector value is 0.75, the actual motion vector value is rounded down to 0, which is closer to the predicted value of −1, and then motion vector value of 1 in the first and second enhancement layers are predicted from the motion vector value of 0 in the base layer.

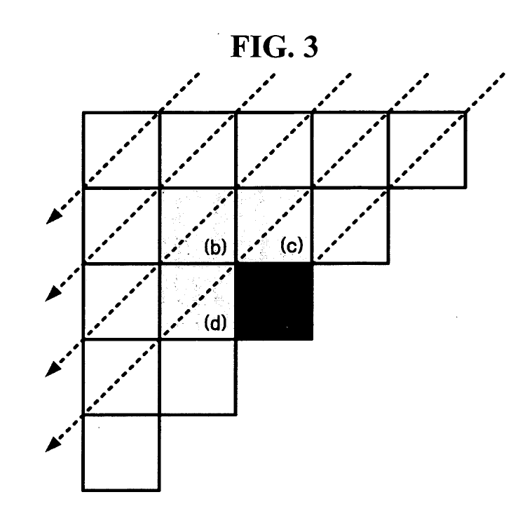

FIG. 3 illustrates an example of obtaining a predicted value for a current block by its correlation with neighboring blocks. Referring to FIG. 3, when motion vectors in a base layer are determined in the diagonal direction, a predicted value of a current block (a) is obtained by correlation with neighboring blocks (b), (c), and (d), whose motion vectors have been determined. The predicted value may be the median or average value of the motion vectors of the neighboring blocks (b), (c), and (d). In the first embodiment, as shown in FIG. 3, an integer value of the current block (a) is found to be closer to a predicted value obtained from neighboring blocks.

According to the first embodiment, since a motion vector component of the base layer is quantized using a residual between the actual value and the predicted value obtained from the neighboring blocks, it is possible to represent the motion vector component of the base layer by the integer value closest to the predicted value, thereby most efficiently quantizing the base layer. As such, this method is efficient in reducing the size of a base layer.

A feature of a second embodiment of the present invention is that an integer motion vector component of a base layer is as close to zero as possible. In the second embodiment, to make the motion vector component of the base layer as close to zero as possible, an actual motion vector is separated into sign and magnitude. The magnitude of the motion vector is represented using an unsigned integer and the original sign is then attached to the unsigned integer. This method makes probable that the motion vector component of the base layer is zero, which enables more efficient quantization since most quantization modules quantize zeros very efficiently. This method is expressed by Equation (1):
x_{b}=sign(x)└|x|┘ (1)
where sign(x) denotes a signal function that returns values of 1 and −1 when x is a positive value and a negative value, respectively, |x| denotes the absolute value of variable x, and └x┘ denotes a function giving the largest integer not exceeding x (by stripping the decimal part).

Table 1 shows examples of values for each layer that can be obtained with the values x and x_{b} in Equation (1). For convenience of explanation, the values x and x_{b} are multiplied by a factor of 4 and expressed as integer values, and 4(x−x_{b}) in the lowest row denotes an error between an actual value and an integer motion vector of the base layer. E1 and E2 respectively denote motion vector components of the first and second enhancement layers, expressed as symbols.

TABLE 1

| | | | | | | | | | | | | | | | |
|---|---|---|---|---|---|---|---|---|---|---|---|---|---|---|---|
| 4χ | −7 | −6 | −5 | −4 | −3 | −2 | −1 | 0 | 1 | 2 | 3 | 4 | 5 | 6 | 7 |
| 4χ_{b} | −4 | −4 | −4 | −4 | 0 | 0 | 0 | 0 | 0 | 0 | 0 | 4 | 4 | 4 | 4 |
| E1 | −1 | −1 | 0 | 0 | −1 | −1 | 0 | 0 | 0 | 1 | 1 | 0 | 0 | 1 | 1 |
| E2 | −1 | 0 | −1 | 0 | 1 | 0 | −1 | 0 | 1 | 0 | −1 | 0 | 1 | 0 | −1 |
| 4(χ− χ_{b)} | −3 | −2 | −1 | 0 | −3 | −2 | −1 | 0 | 1 | 2 | 3 | 0 | 1 | 2 | 3 |

As is evident from Table 1, the method of the second embodiment provides higher possibility that the integer, motion vector component x_{b} of the base layer has more zeros, thereby increasing the compression efficiency as compared to the first embodiment in which x_{b} is obtained by simply truncating the decimal part (x_{b}=└x┘). However, like in the first embodiment, motion vector components of the first and second enhancement layers are expressed as the symbols −1, 0, or 1, which results in reduced efficiency. Furthermore, like the first embodiment, the second embodiment suffers from a significant distortion caused by a difference—as much as 0.75—between actual and quantized motion vectors even when only the base layer is used.

In a third embodiment of the present invention, the difference between an actual motion vector and a quantized motion vector of a base layer is minimized. That is, the third embodiment concentrates on reducing that difference to less than 0.5, which is an improvement over the first and second embodiments where the maximum difference is 0.75. This is accomplished by modifying the second embodiment to some extent. That is, an integer nearest to an actual motion vector is selected as a motion vector component of the base layer by rounding off the actual motion vector, as defined by Equation (2):
x_{b}=sign(x)└|x|+0.5┘ (2)

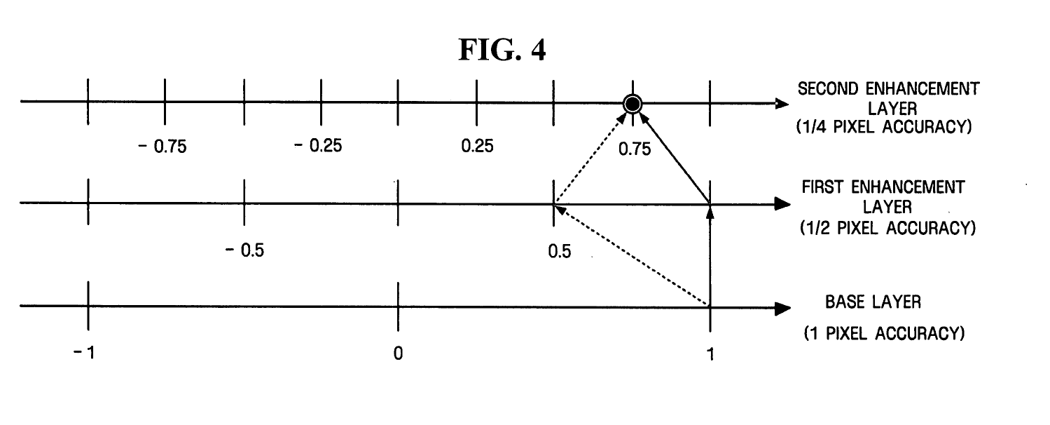

Equation (2) is similar to Equation (1) except for the use of rounding off. FIG. 4 shows an example in which a motion vector with a value of 0.75 is represented according to the third embodiment of the present invention. Referring to FIG. 4, unlike the first and second embodiments, the value 1 is selected as a motion vector component of a base layer since 1 is an integer nearest to the actual motion vector of 0.75. As shown in FIG. 4, a motion vector component of the first enhancement layer that minimizes the difference between the actual motion vector and the motion vector of the first enhancement layer may be −0.5 or 0 (a motion vector of the first enhancement layer is sum of a motion vector of the base layer and a motion vector component of the first enhancement layer).

In either case, the minimum difference is 0.25. When two or more values with the minimum error are present in the first enhancement layer, the value closest to the motion vector component of the immediately lower layer is chosen as the motion vector component of the first enhancement layer.

Thus, the value 0 is finally selected as the motion vector component of the first enhancement layer.

By doing so, the difference between the actual motion vector and the motion vector component of the base layer can be reduced to 0.25. The third embodiment of the present invention provides improved coding performance when only a base layer is used by limiting the difference to below 0.5. However, this method has the drawback of increasing the size of the base layer over the first or second embodiments. Table 2 shows examples of values that can be created by Equation (2).

TABLE 2

| | | | | | | | | | | | | | | | |
|---|---|---|---|---|---|---|---|---|---|---|---|---|---|---|---|
| 4χ | −7 | −6 | −5 | −4 | −3 | −2 | −1 | 0 | 1 | 2 | 3 | 4 | 5 | 6 | 7 |
| 4χ_{b} | −8 | −8 | −4 | −4 | −4 | −4 | 0 | 0 | 0 | 4 | 4 | 4 | 4 | 8 | 8 |
| E1 | 0 | 1 | 0 | 0 | 0 | 1 | 0 | 0 | 0 | −1 | 0 | 0 | 0 | −1 | 0 |
| E2 | 1 | 0 | −1 | 0 | 1 | 0 | −1 | 0 | 1 | 0 | −1 | 0 | 1 | 0 | −1 |
| 4(χ− χ_{b)} | 1 | 2 | −1 | 0 | 1 | 2 | −1 | 0 | 1 | 2 | −1 | 0 | 1 | 2 | −1 |

As is evident from Table (2), in the third embodiment there is a higher probability that the motion vector component E1 of the first enhancement layer will be zero, which results in higher compression efficiency. However, the motion vector component E2 of the second enhancement layer is more complicated so more bits are allocated for coding. In particular, 4(x−x_{b}) in the lowest row indicates that the difference between the motion vector component of the base layer and the actual motion vector is less than 0.5.

Table 3 shows the results of experiments where a Foreman CIF sequence is compressed at frame rate of 30 Hz and at bitrate of 256 Kbps. The experiments were done to verify the performance of the first through third embodiments of the present invention. Table 3 lists the number of bits (hereinafter “size” will refer to “number of bits”) needed for motion vectors of a base layer and first and second enhancement layers according to the first through third embodiments.

TABLE 3

| | First embodiment | Second embodiment | Third embodiment |
|---|---|---|---|
| Base | 42.76 | 45.35 | 48.12 |
| E1 | 20.87 | 21.56 | 13.20 |
| E2 | 24.08 | 24.14 | 24.12 |
| Total | 87.71 | 91.05 | 85.44 |

As evident from Table 3, a base layer has the smallest size in the first embodiment, but the first and second enhancement layers have the largest size since a motion vector of a base layer is predicted, thus increasing the total size. While attempting to reduce the size of a motion vector component of a base layer by assigning more zeros to it, the second embodiment increases the size of a base layer as well as a total size compared to the first embodiment. The total size is the largest in the second embodiment.

In the third embodiment, the base layer has the largest size but the first enhancement layer has the smallest size since it is highly probable that a motion vector component of the first enhancement layer will have a value of zero. The second enhancement layer has a size similar to its counterparts in the first and second embodiments.

When only the base layer is used for coding, it is advantageous to select a method where the base layer has the smallest size. When all layers are used for coding, a method that minimizes the total size may be selected. In the former case, the first embodiment is selected, and in the latter case the third embodiment is selected.

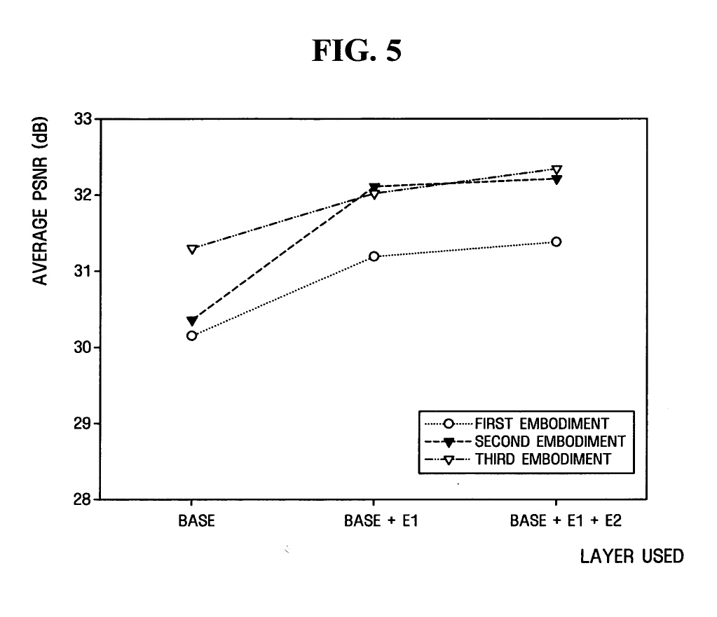

FIG. 5 is a graph illustrating the results of measuring PSNRs (as a video quality indicator) using motion vectors from the three layers according to the first through third embodiments of the present invention as detailed in Table 3. Referring to FIG. 5, the third embodiment exhibits the highest performance while the first embodiment exhibits the poorest performance.

In particular, the first embodiment has similar performance to the second embodiment when only a base layer is used while it has weak performance compared to the other embodiments when all motion vector layers are used.

It should be especially noted that the third embodiment exhibits superior performance when only the base layer is used. Specifically, the PSNR value in the third embodiment is more than 1.0 dB higher than that of the second embodiment. This is achieved by minimizing the difference between an integer motion vector component of the base layer and an actual motion vector. That is, since it is more efficient for coding performance to minimize this difference than to slightly decrease an integer value, the third embodiment exhibits the best performance.

### Method of Efficiently Compressing the Enhancement Layer

Referring to Table 3, the third embodiment is superior to the first and second embodiments in terms of the size of the first enhancement layer, but it has little difference in terms of the size of the second enhancement layer. Thus, for low bitrate coding where the size of the motion vector largely affects the performance, the third embodiment is not advantageous over the others when all motion vector layers are used.

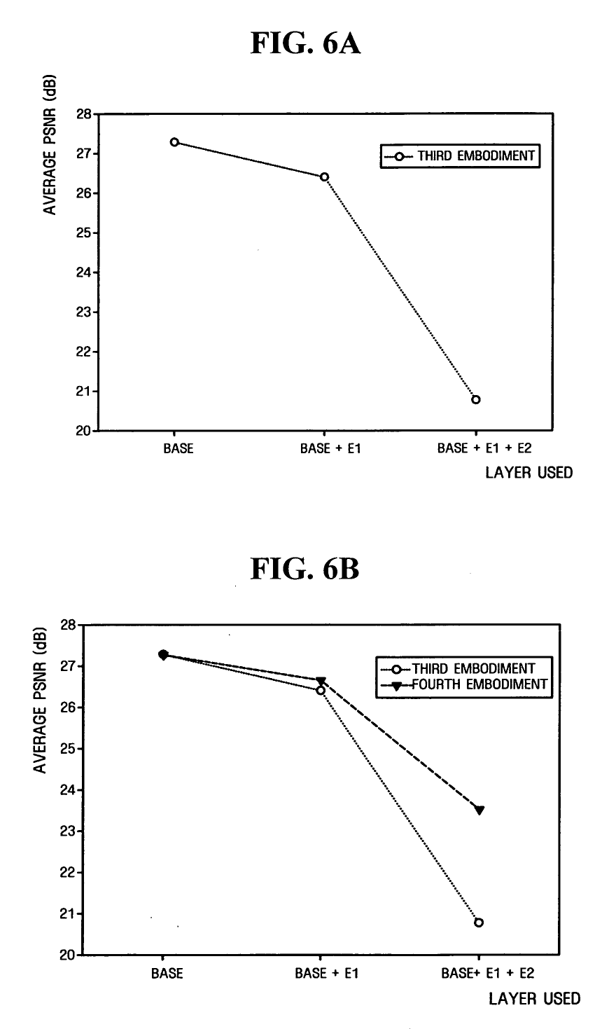

FIG. 6A is a graph illustrating an experimental result of compressing a Foreman CIF sequence at 100 Kbps according to the third embodiment.

As evident from FIG. 6A, since the 100 kbps is a low bitrate, the third embodiment exhibits superior performance when only the base layer is used, compared to when all the layers are used. Specifically, while the third embodiment shows excellent performance when the base layer or a combination of the base layer and the first enhancement layer is used, its performance degrades when all the layers are used since the size of the second enhancement layer is large.

However, the third embodiment is intended to allocate a large amount of information to the second enhancement layer. Since the second enhancement layer is used only for a sufficient bitrate, its large size does not significantly affect performance. For a low bitrate, only the base layer and the first enhancement layer are used, and bits in the second enhancement layer can be truncated.

In order to prevent significant degradation due to the presence of the second enhancement layer in the third embodiment, the present invention proposes a method for providing excellent coding performance when all motion vector layers are used by adding two compression rules.

The two compression rules are found in Table 2. Referring to Table 2, the first rule is that the motion vector component (4x_{b}) of the base layer has an opposite sign to the motion vector component E1 of the first enhancement layer except, of course, when E1 is zero. In other words, the motion vector component E1 of the first enhancement layer is represented by 0 or 1, and when E1 is 1, a decoder reconstructs the original value of E1 by attaching a sign to E1, which is opposite to the sign of the motion vector component of the base layer.

That is, since E1 has an opposite sign to the motion vector component of the base layer (except zero, which has no sign), E1 can be expressed as either 0 or 1. An encoder converts −1 to 1 while a decoder can reconstruct the original value of E1 by attaching the opposite sign to 1.

By applying the first rule, entropy coding efficiency can be improved since the motion vector component E1 of the first enhancement layer can be expressed as either 0 or 1. An experimental result demonstrated that applying the first rule alone reduces the number of bits by more than 12%.

Referring to Table 2, the second compression rule is that the motion vector component E2 of the second enhancement layer is always 0 when E1 is 1 or −1. Thus, E2 is not encoded when a corresponding E1 is not 0.

In other words, an encoder does not encode E2 when E1 is not 0. A decoder uses 0 as E2 when E1 is not 0, and the received value as E2 when E1 is 0.

An experimental result demonstrated that applying the second rule reduces the number of bits by about 25% and by about 12% after entropy encoding. This compensates for the drawback of the third embodiment caused by the large second enhancement layer. Table 4 shows the values of Table 2 after applying the first and second compression rules.

TABLE 4

| | | | | | | | | | | | | | | | |
|---|---|---|---|---|---|---|---|---|---|---|---|---|---|---|---|
| 4χ | −7 | −6 | −5 | −4 | −3 | −2 | −1 | 0 | 1 | 2 | 3 | 4 | 5 | 6 | 7 |
| 4χ_{b} | −8 | −8 | −4 | −4 | −4 | −4 | 0 | 0 | 0 | 4 | 4 | 4 | 4 | 8 | 8 |
| E1 | 0 | 1 | 0 | 0 | 0 | 1 | 0 | 0 | 0 | 1 | 0 | 0 | 0 | 1 | 0 |
| E2 | 1 | X | −1 | 0 | 1 | X | −1 | 0 | 1 | X | −1 | 0 | 1 | X | −1 |

The symbol “X” in Table 4 denotes a portion not transmitted, and this constitutes a quarter of the total number of cases. Thus, the number of bits can be reduced by 25%. By converting −1 to 1 in the first enhancement layer, compression efficiency can be further increased. A method created by applying the first and second compression rules to the third embodiment is referred to as a ‘fourth embodiment’. The compression rules in the fourth embodiment can also be applied to a base layer, a first enhancement layer, and a second enhancement layer for a motion vector consisting of four or more layers. Furthermore, either the first or second or both rules can be applied depending on the type of application.

Table 5 shows the number of bits needed for motion vectors of a base layer, a first enhancement layer, and a second enhancement layer according to the fourth embodiment of the present invention.

TABLE 5

| | Third embodiment | Fourth embodiment | Reduction rate (%) |
|---|---|---|---|
| Base | 48.12 | 48.12 | 0 |
| E1 | 13.20 | 11.13 | 15.68 |
| E2 | 24.12 | 21.25 | 11.90 |
| Total | 85.44 | 80.50 | 5.8 |

As detailed in Table 5, the fourth embodiment reduces the sizes of the first and second enhancement layers by 15.68% and 11.90% compared to the third embodiment, thereby significantly reducing the overall bitrate. The number of bits in the second enhancement layer is reduced by less than 25% since the value of the omitted bits is zero and are efficiently compressed by an entropy encoding module.

Nevertheless, the number of bits can be reduced by approximately 12%. FIG. 6B is a graph comparing the experimental results of the third embodiment (FIG. 6A) and the fourth embodiment of the present invention. As shown in FIG. 6B, the fourth embodiment exhibits similar performance to the third embodiment when only the base layer is used, but exhibits superior performance thereto when all the layers are used.

While it is described above that a motion vector consists of three layers, it will be understood by those skilled in the art that the present invention can apply to a motion vector consisting of more than three layers. Furthermore, it is described above that a motion vector search is performed on a base layer with 1 pixel accuracy, a first enhancement layer with ½ pixel accuracy, and a second enhancement layer with ¼ pixel accuracy. However, this is provided as an example only, and it will be readily apparent to those skilled in the art that the motion vector search may be performed with different pixel accuracies than those stated above. Although, the pixel accuracies increase with each layer, in a manner similar to the afore-mentioned embodiments.

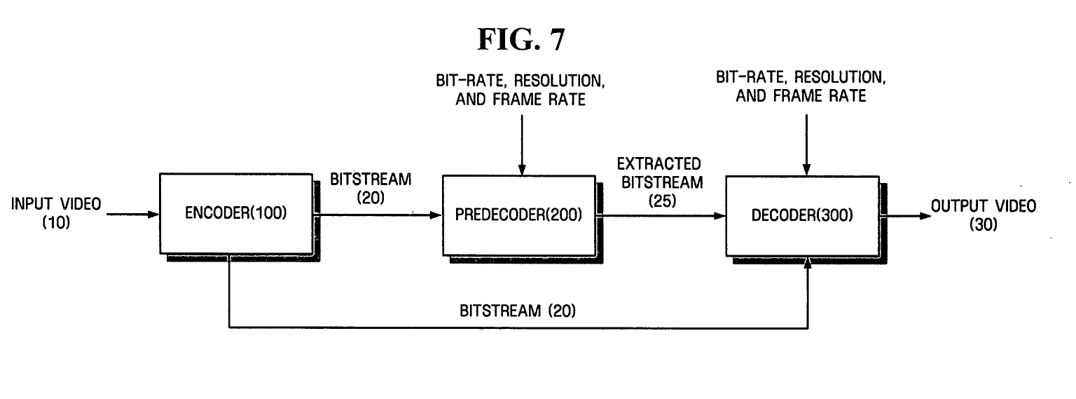

In order to implement motion scalability, an encoder encodes an input video using a multilayered motion vector while a predecoder or a decoder decodes all or part of the input video. The overall process will now be described schematically with reference to FIG. 7.

FIG. 7 shows the overall configuration of a video coding system. Referring to FIG. 7, the video coding system includes an encoder 100, a predecoder 200, and a decoder 300. The encoder 100 encodes an input video into a bitstream 20. The predecoder 200 truncates part of the texture data in the bitstream 20 according to extraction conditions such as bitrate, resolution or frame rate determined considering the communication environment. The decoder 300, therefore, implements scalability for the texture data. The predecoder 200 also implements motion scalability by truncating part of the motion data in the bitstream 20 in an order from the highest to the lowest layers according to the communication environment or the number of texture bits. By implementing texture or motion scalability in this way, the predecoder can extract various bitstreams 25 from the original bitstream 20.

The decoder 300 generates an output video 30 from the extracted bitstream 25. Of course, either the predecoder 200 or the decoder 300 or both may extract the bitstream 25 according to the extraction conditions.

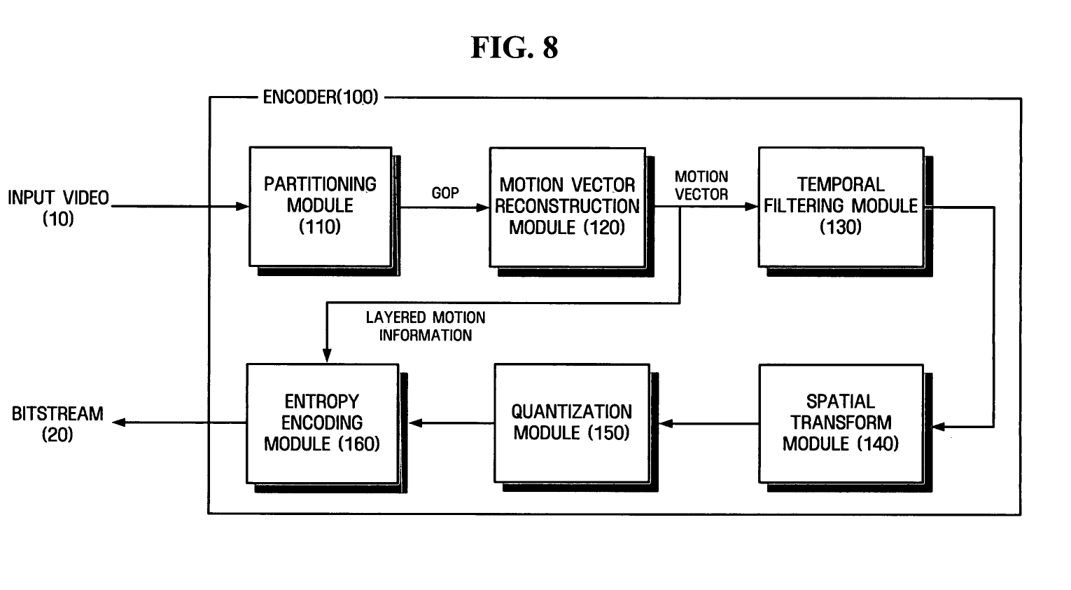

FIG. 8 is a block diagram of an encoder 100 of a video coding system. The encoder 100 includes a partitioning module 110, a motion vector reconstruction module 120, a temporal filtering module 130, a spatial transform module 140, a quantization module 150, and an entropy encoding module 160.

The partitioning module 110 partitions an input video 10 into several groups of pictures (GOPs), each of which is independently encoded as a unit.

The motion vector reconstruction module 120 finds an actual motion vector for a frame of one GOP with the predetermined pixel accuracy, and sends the motion vector to the temporal filtering module 130. The motion vector reconstruction module 120 uses this actual motion vector and a predetermined method (one of first through third embodiments) to determine a motion vector component of the base layer. Next, it determines a motion vector component of an enhancement layer with the enhancement layer pixel accuracy that is closer to the actual motion vector. The motion vector reconstruction module 120 also sends an integer motion vector component of the base layer and a symbol value that is the motion vector component of the enhancement layer to the entropy encoding module 160. The multilayered motion information is encoded by the entropy encoding module 160 using a predetermined encoding algorithm.

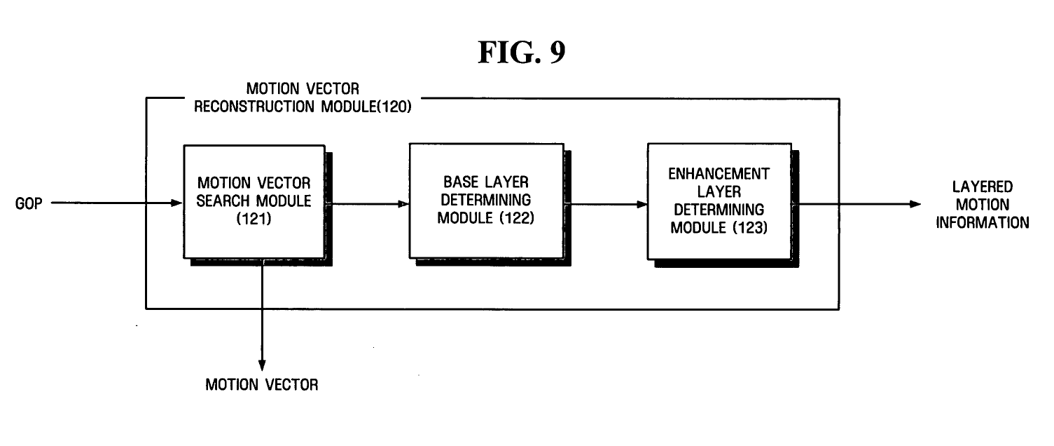

FIG. 9 is a block diagram of an exemplary motion vector reconstruction module 120 according to the present invention. Referring to FIG. 9, the motion vector reconstruction module 120 includes a motion vector search module 121, a base layer determining module 122, and an enhancement layer determining module 123.

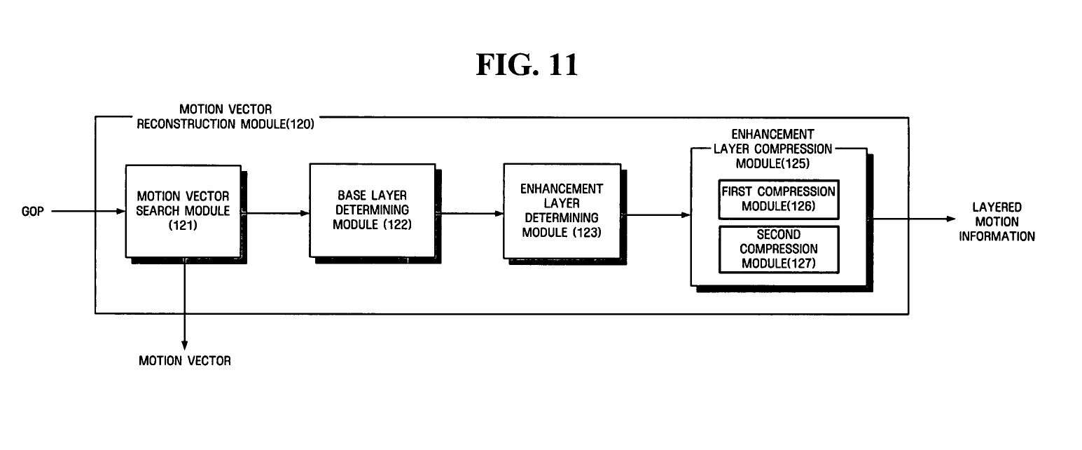

Referring to FIG. 11, in order to implement the afore-mentioned fourth embodiment of the present invention, the motion vector reconstruction module 120 further includes an enhancement layer compression module 125 with either a first or second compression module 126 or 127 or both.

The motion vector search module 121 performs a motion vector search of each block in a current frame (at a predetermined pixel accuracy) in order to obtain an actual motion vector. The block may be a fixed variable size block. When a variable size block is used, information about the block size (or mode) needs to be transmitted together with the actual motion vector.

In general, to accomplish a motion vector search, a current image frame is partitioned into blocks of a predetermined pixel size, and a block in a reference image frame is compared with the corresponding block in the current image frame according to the predetermined pixel accuracy in order to derive the difference between the two blocks. A motion vector that gives the minimum sum of errors is designated as the motion vector for the current block. A search range may be predefined using parameters. A smaller search range reduces search time and exhibits good performance when a motion vector exists within the search range. However, the prediction accuracy will be decreased for a fast-motion image where the motion vector does not exist within the range.

Motion estimation may be performed using variable size blocks instead of the above fixed-size block. In motion estimation using a variable size block, a motion vector search is performed on blocks of variable pixel sizes to determine a variable block size and a motion vector that minimize a predetermined cost function J.

The cost function is defined by Equation (3):
J=D+λ×R (3)
where D is the number of bits used for coding a frame difference, R is the number of bits used for coding an estimated motion vector, and λ is a Lagrangian coefficient.

The base layer determining module 122 determines an integer motion vector component of a base layer according to the first through third embodiments. In the first embodiment, it determines the motion vector component of the base layer by spatial correlation with the motion vector components of neighboring blocks and rounding up or down the decimal part of the actual motion vector.

In the second embodiment, the base layer determining module 122 determines the motion vector component of the base layer by separating the actual motion vector into a sign and a magnitude. The magnitude of the motion vector is represented by an unsigned integer to which the original sign is attached. The determination process is shown in Equation (1).

In the third embodiment, the base layer determining module 122 determines the motion vector component of the base layer by finding an integer value nearest to the actual motion vector. This nearest integer value is calculated by Equation (2).

The enhancement layer determining module 123 determines a motion vector component of an enhancement layer in such a way as to minimize an error between the actual motion vector and the motion vector component. When two or more vectors with the same error exist, the motion vector that minimizes the error of the motion vector in the immediately lower layer is chosen as the motion vector component of the enhancement layer.

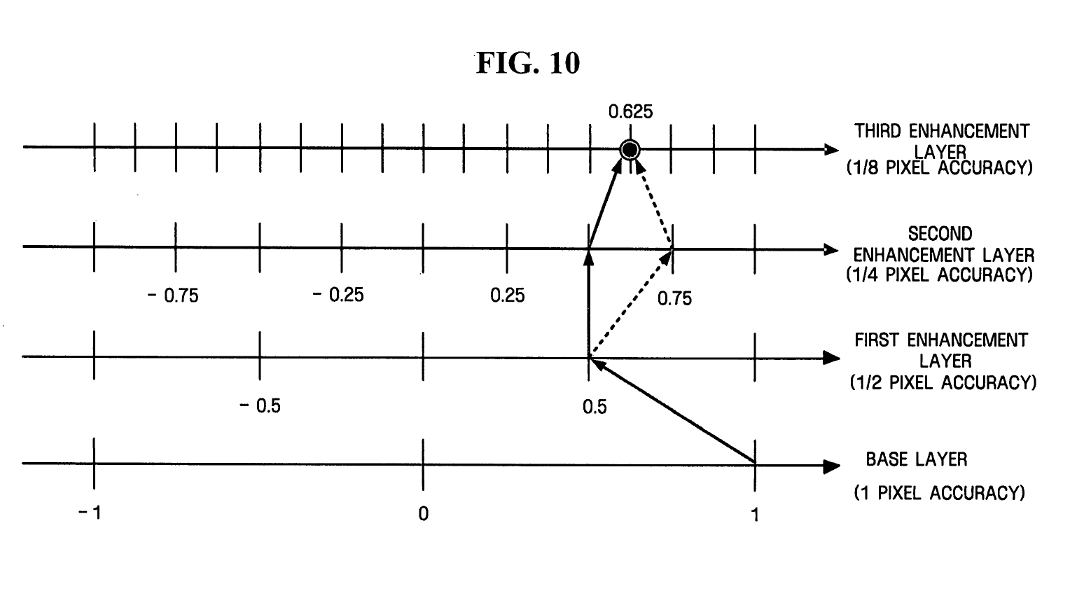

For example, when a motion vector consists of four layers as shown in FIG. 10, a motion vector component of a base layer is determined according to the first through third embodiments and motion vector components of the first through third enhancement layers are determined using a separate method. Assuming that the value 1 is determined as the motion vector component of the base layer according to one of the first through third embodiments, a process for determining the motion vector components of the enhancement layers will now be described with reference to FIG. 10. Here, a “cumulative value” of a layer is defined as the sum of motion vector components of the lower layers.

Referring to FIG. 10, when the cumulative value of the first enhancement layer is set to 0.5 as it is the closest value to 0.625, −0.5 is determined to be the motion vector component of the first enhancement layer. Two cumulative values 0.5 and 0.75, having the same error relative to 0.625, exist in the second enhancement layer, but 0.5 is selected since it is closer to the cumulative value of the first enhancement layer. Thus, 0 is determined as a motion vector component of the second enhancement layer, and then 0.125 is determined as the motion vector component of the third enhancement layer.

In order to implement the aforementioned method according to the fourth embodiment of the present invention, the motion vector reconstruction module 120 further includes the enhancement layer compression module 125 with either the first or second compression module 126 or 127 or both as shown in FIG. 11.

When the motion vector component of the first enhancement layer is a negative number, the first compression module 126 converts the negative number into a positive number having the same magnitude. When the motion vector component of the first enhancement layer is not 0, the second compression module 127 does not encode the motion vector component of the second enhancement layer.

Referring to FIG. 8, to reduce temporal redundancies, the temporal filtering module 130 uses motion vectors obtained by the motion vector reconstruction module 121 to decompose frames into low-pass and high-pass frames in the direction of a temporal axis. A temporal filtering algorithm such as Motion Compensated Temporal Filtering (MCTF) or Unconstrained MCTF (UMCTF) can be used.

The spatial transform module 140 removes spatial redundancies from these frames using the discrete cosine transform (DCT) or wavelet transform, and creates transform coefficients.

The quantization module 150 quantizes those transform coefficients. Quantization is the process of converting real transform coefficients into discrete values and mapping the quantized coefficients into quantization indices. In particular, when a wavelet transform is used for spatial transformation, embedded quantization can often be used. Embedded ZeroTrees Wavelet (EZW), Set Partitioning in Hierarchical Trees (SPIHT), and Embedded ZeroBlock Coding (EZBC) are examples of an embedded quantization algorithm.

The entropy encoding module 160 losslessly encodes the transform coefficients quantized by the quantization module 150 and the motion information generated by the motion vector reconstruction module 120 into a bitstream 20. For entropy encoding, various techniques such as arithmetic encoding and variable-length encoding may be used.

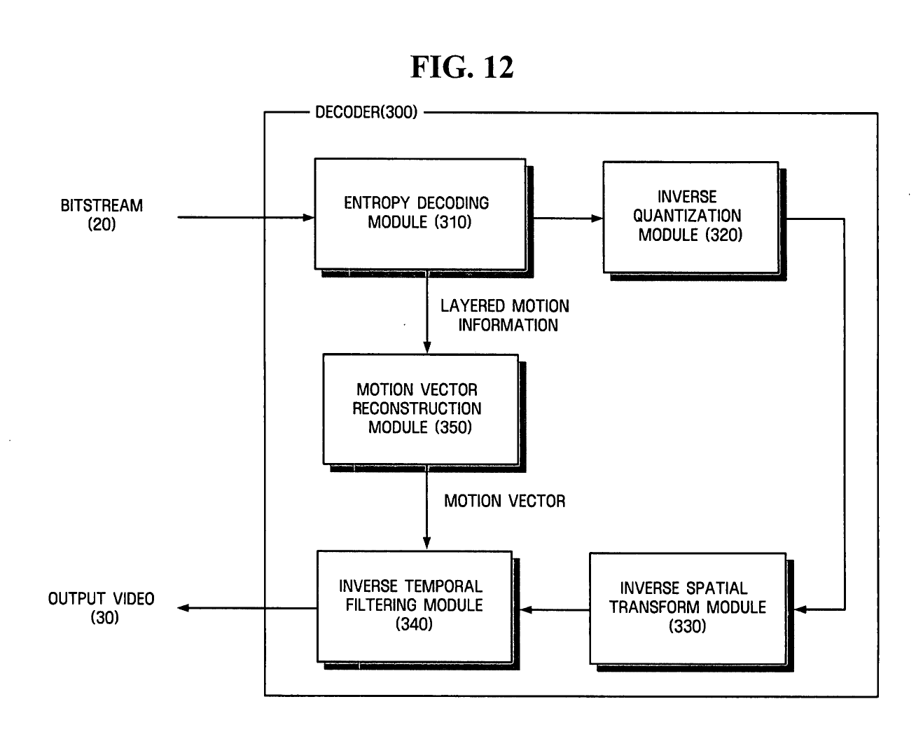

FIG. 12 is a block diagram of a decoder 300 in a video coding system according to an embodiment of the present invention.

The decoder 300 includes an entropy decoding module 310, an inverse quantization module 320, an inverse spatial transform module 330, an inverse temporal filtering module 340, and a motion vector reconstruction module 350.

The entropy decoding module 310 performs the inverse of an entropy encoding process to extract texture information (encoded frame data) and motion information from the bitstream 20.

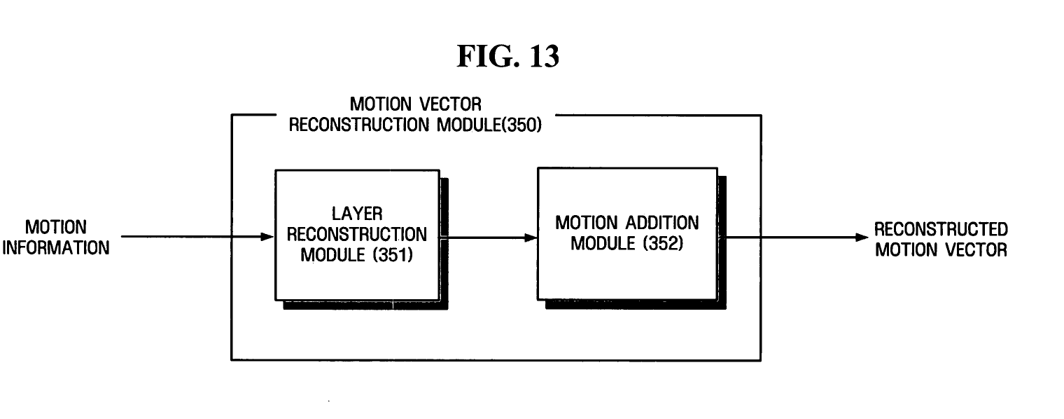

FIG. 13 is a block diagram of an exemplary motion vector reconstruction module 350 according to the present invention. The motion vector reconstruction module 350 includes a layer reconstruction module 351 and a motion addition module 352.

The layer reconstruction module 351 interprets the extracted motion information and recognizes motion information for each layer. The motion information contains block information and motion vector information for each layer. The layer reconstruction module 351 then reconstructs a motion vector component of each layer from a corresponding layer value contained in the motion information. Here, the “layer value” means a value received from the encoder. Specifically, an integer value representing a motion vector component of a base layer or a symbol value representing a motion vector component of an enhancement layer. When the layer value is a symbol value, the layer reconstruction module 351 reconstructs the original motion vector component from the symbol value.

The motion addition module 352 reconstructs a motion vector by adding the motion vector components of the base layer and the enhancement layer together and sending the motion vector to the inverse temporal filtering module 340.

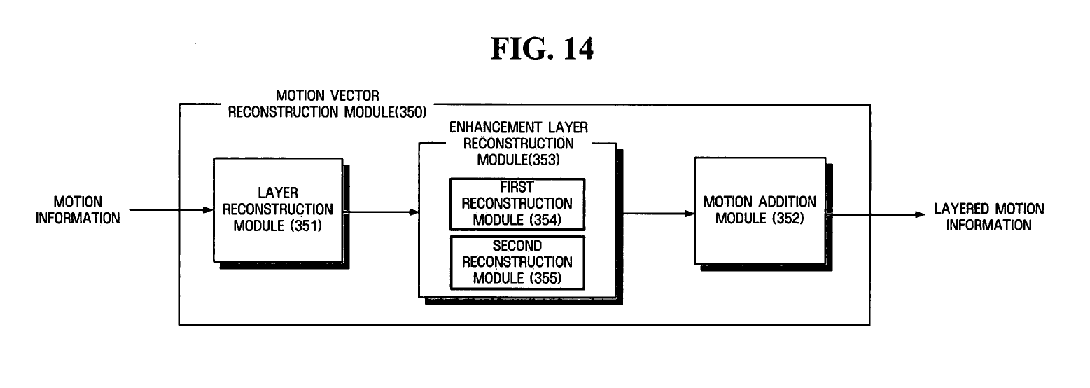

FIG. 14 is a block diagram of another exemplary motion vector reconstruction module 350 for implementing the method according to the fourth embodiment of the present invention.

Referring to FIG. 14, the motion vector reconstruction module 350 includes a layer reconstruction module 351, a motion addition module 352, and an enhancement layer reconstruction module 353 with either first or second reconstruction modules 354 and 355 or both.

In order to reconstruct a motion vector component of a first enhancement layer when a value of the extracted information of the first enhancement layer is not 0, the first reconstruction module 354 attaches a sign to this value that is opposite to the sign of a motion vector component of a base layer, and obtains a motion vector component corresponding to the resultant value (symbol). When the value of the extracted information of the first enhancement layer is 0, the motion vector component is 0.

In order to reconstruct a motion vector component of a second enhancement layer, the second reconstruction module 355 sets the value of motion vector component of the second enhancement layer to 0 when the value of the first enhancement layer is not 0. When the value is 0, the second reconstruction module obtains a motion vector component corresponding to a value of the second enhancement layer. Then, the motion addition module 352 reconstructs a motion vector by adding the motion vector components of the base layer and the first and second enhancement layers together.

The inverse quantization module 320 performs inverse quantization on the extracted texture information and outputs transform coefficients. Inverse quantization is the process of obtaining quantized coefficients from quantization indices received from the encoder 100. A mapping table of indices and quantization coefficients is received from the encoder 100.

The inverse of spatial transform, the inverse spatial transform module 330 inverse-transforms the transform coefficients into transform coefficients in a spatial domain. For example, in the DCT transform the transform coefficients are inverse-transformed from the frequency domain to the spatial domain. In the wavelet transform, the transform coefficients are inversely transformed from the wavelet domain to the spatial domain.

The inverse temporal filtering module 340 performs inverse temporal filtering on the transform coefficients in the spatial domain (i.e., a temporal residual image) using the reconstructed motion vectors received from the motion vector reconstruction module 350 in order to reconstruct frames making up a video sequence.

The term “module”, as used herein refers to, but is not limited to, a software or hardware component such as a Field Programmable Gate Array (FPGA) or an Application Specific Integrated Circuit (ASIC), which performs certain tasks. A module may advantageously be configured to reside on the addressable storage medium and to execute on one or more processors. Thus, a module may include, by way of example, components such as software components, object-oriented software components, class components and task components, processes, functions, attributes, procedures, subroutines, segments of program code, drivers, firmware, microcode, circuitry, data, databases, data structures, tables, arrays, or variables. The functionality provided for in the components and modules may be combined into fewer components and modules or further separated into additional components and modules. In addition, the components and modules may be implemented such a way that they execute one or more computers in a communication system.

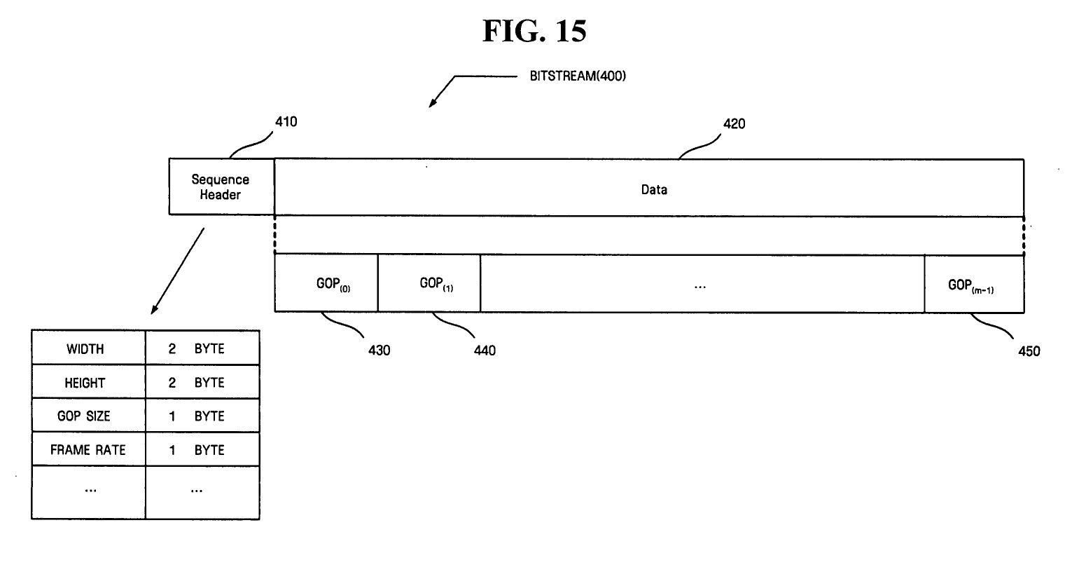

FIGS. 15 through 17 illustrate a structure of a bitstream 400. Specifically, FIG. 15 is a schematic diagram illustrating an overall structure of the bitstream 400.

The bitstream 400 is composed of a sequence header field 410 and a data field 420 containing a plurality of GOP fields 430 through 450.

The sequence header field 410 specifies image properties such as frame width (2 bytes) and height (2 bytes), a GOP size (I byte), and a frame rate (1 byte).

The data field 420 contains all the image information and other information (motion vector, reference frame number, etc.) needed to reconstruct an image.

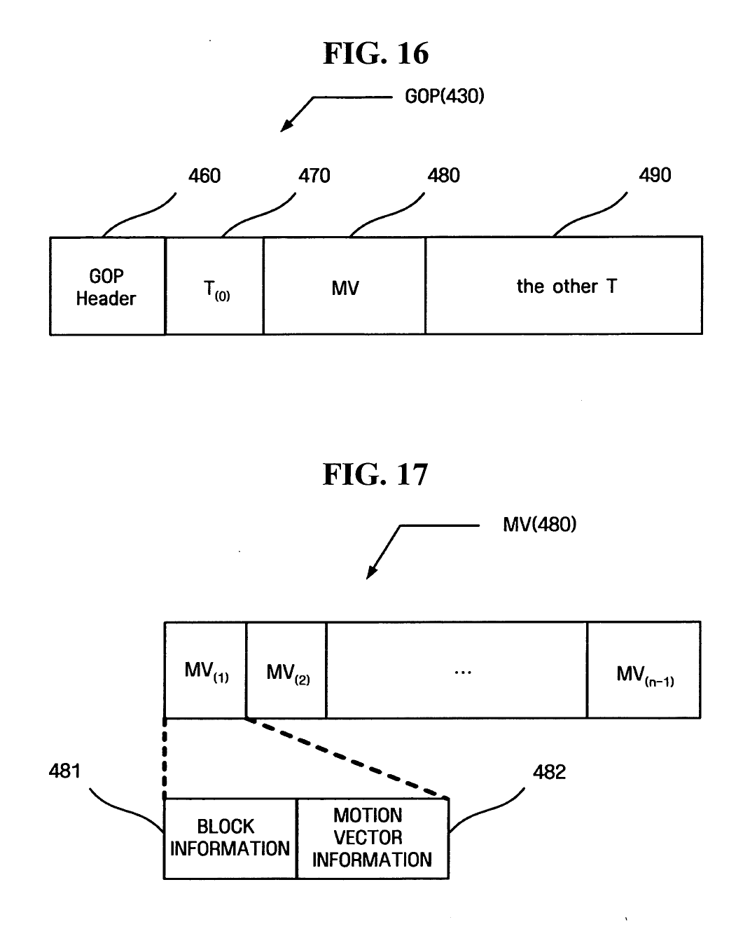

FIG. 16 shows the detailed structure of each GOP field 430. Referring to FIG. 16, the GOP field 430 consists of a GOP header 460, a T₍₀₎ field 470 that specifies information about a first frame (encoded without reference to another frame) and that has been subjected to temporal filtering, a motion vector (MV) field 480 specifying a set of motion vectors, and a “the other T” field 490 specifying information on frames other than the first frame (encoded with reference to another frame).

Unlike the sequence header field 410 that specifies properties of the entire video sequence, the GOP header field 460 specifies image properties of a GOP such as temporal filtering order.

FIG. 17 shows the detailed structure of the MV field 480 consisting of MV₍₁₎ through MV₍ₙ₋₁₎ fields.

Referring to FIG. 17, each of the MV₍₁₎ through MV₍ₙ₋₁₎ fields specifies variable size block information such as size and position of each variable size block and motion vector information (symbols representing motion vector components) for each layer.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

The present invention reduces the size of an enhancement layer while minimizing an error in a base layer. The present invention also enables adaptive allocation of the amount of bits between motion information and texture information using motion scalability.

1. An apparatus for reconstructing a motion vector obtained at a predetermined pixel accuracy, the apparatus comprising:
a base layer determining module determining a motion vector component of a base layer using the obtained motion vector according to a pixel accuracy of the base layer; and
an enhancement layer determining module determining a motion vector component of an enhancement layer according to a pixel accuracy of the enhancement layer, so that a sum of the motion vector component of the enhancement layer and the motion vector component of the base layer is close to the obtained motion vector.

2. The apparatus of claim 1, wherein the base layer determining module determines the motion vector component of the base layer that is close to a value predicted from motion vectors of neighboring blocks according to the pixel accuracy of the base layer.

3. The apparatus of claim 1, wherein in order to determine the motion vector component of the base layer according to the pixel accuracy of the base layer, the base layer determining module separates the obtained motion vector into an original sign and a magnitude, uses an unsigned value to represent the magnitude of the motion vector, and attaches the original sign to the unsigned value.

4. The apparatus of claim 1, wherein the base layer determining module determines a value closest to the obtained motion vector as the motion vector component of the base layer according to the pixel accuracy of the base layer.

5. The apparatus of claim 4, wherein the motion vector component of the base layer is x_{b} and is determined using x_{b}=sign(x)└|x|+0.5┘, where sign(x) denotes a signal function that returns values of 1 and −1 when variable x is a positive value and a negative value, respectively, |x| denotes an absolute value function with respect to the variable x, and └|x|+0.5┘ denotes a function that gives a largest integer not exceeding |x|+0.5 by stripping a decimal part.

6. The apparatus of claim 4, further comprising a first compression module removing redundancy in a motion vector component of a first enhancement layer using a first relationship wherein a sign of the motion vector component of the first enhancement layer is the opposite to a sign of the motion vector component of the base layer when the motion vector component of the first enhancement layer is not 0.

7. The apparatus of claim 6, further comprising a second compression module removing redundancy in a motion vector component of a second enhancement layer using a second relationship wherein the motion vector component of the second enhancement layer is always 0 when the motion vector component of the first enhancement layer is not 0.

8. A video encoder using a motion vector consisting of multiple layers, the encoder comprising:
a motion vector reconstruction module including a motion vector search module obtaining the motion vector with a predetermined pixel accuracy, a base layer determining module determining a motion vector component of a base layer using the obtained motion vector according to a pixel accuracy of the base layer;
an enhancement layer determining module determining a motion vector component of an enhancement layer so that a sum of the motion vector component of the enhancement layer and the motion vector component of the base layer is close to the obtained motion vector according to a pixel accuracy of the enhancement layer;
a temporal filtering module removing temporal redundancies by filtering frames in a direction of a temporal axis using the obtained motion vector;
a spatial transform module removing spatial redundancies from the filtered frames from which the temporal redundancies have been removed and creating transform coefficients; and
a quantization module performing quantization on the transform coefficients.

9. An apparatus for reconstructing a motion vector consisting of a base layer and at least one enhancement layer, the apparatus comprising:
a layer reconstruction module reconstructing a motion vector component of the base layer and a motion vector component of the at least one enhancement layer from a value of the base layer and a value of the at least one enhancement layer, respectively, the values of the base layer and the at least one enhancement layer being interpreted from an input bitstream; and
a motion addition module adding the reconstructed motion vector components of the base layer and the at least one enhancement layer together and providing the motion vector.

10. An apparatus for reconstructing a motion vector consisting of a base layer and at least one enhancement layer, the apparatus comprising:
a first reconstruction module reconstructing a motion vector component of a first enhancement layer by attaching a sign to a value of the first enhancement layer interpreted from an input bitstream, which is opposite to a sign of a corresponding value of the base layer;
a layer reconstruction module reconstructing a motion vector component of the base layer and a motion vector component of at least one enhancement layer other than the first enhancement layer from the corresponding value of the base layer and a value of the at least one enhancement layer other than the first enhancement layer, respectively, the corresponding value of the base layer and the value of the at least one enhancement layer other than the first enhancement layer being interpreted from the input bitstream; and
a motion addition module adding the reconstructed motion vector components of the base layer, the first enhancement layer, and the least one enhancement layer other than the first enhancement layer together and providing the motion vector.

11. An apparatus for reconstructing a motion vector consisting of a base layer and at least one enhancement layer, the apparatus comprising:
a first reconstruction module reconstructing a motion vector component of a first enhancement layer by attaching a sign to a value of the first enhancement layer interpreted from an input bitstream, which is opposite to a sign of a corresponding value of the base layer;
a second reconstruction module setting a motion vector component of a second enhancement layer to 0 when the value of the first enhancement layer is not 0 and reconstructing the motion vector component of the second enhancement layer from a value of the second enhancement layer interpreted from the input bitstream when the value of the first enhancement layer is 0;
a layer reconstruction module reconstructing a motion vector component of the base layer and a motion vector component of a third enhancement layer other than the first and the second enhancement layers from the corresponding value of the base layer and a value of the third enhancement layer, respectively, the corresponding value of the base layer and the value of the third enhancement layer being interpreted from the input bitstream; and
a motion addition module adding the reconstructed motion vector component of the base layer and the reconstructed motion vector components of the first, the second, and the third enhancement layers together and providing the motion vector.

12. A video decoder using a motion vector consisting of multiple layers, the decoder comprising:
an entropy decoding module interpreting an input bitstream and extracting texture information and motion information from the bitstream;
a motion vector reconstruction module reconstructing motion vector components of the multiple layers from corresponding values of the multiple layers contained in the extracted motion information and providing the motion vector after adding the motion vector components of the multiple layers together;
an inverse quantization module applying inverse quantization to the texture information and outputting transform coefficients;
an inverse spatial transform module inversely transforming the transform coefficients into transform coefficients in a spatial domain by performing an inverse of a spatial transform; and
an inverse temporal filtering module performing inverse temporal filtering on the inversely transformed transform coefficients in the spatial domain using the provided motion vector and reconstructing frames in a video sequence.

13. The decoder of claim 12, wherein the motion vector reconstruction module comprises:
a first reconstruction module reconstructing a motion vector component of a first enhancement layer by attaching a sign to a value of the first enhancement layer contained in the motion information, which is opposite to a sign of a corresponding value of a base layer;
a layer reconstruction module reconstructing a motion vector component of the base layer and a motion vector component of at least one enhancement layer other than the first enhancement layer from the corresponding value of the base layer and a value of the enhancement layer other than the first enhancement layer, respectively; and
a motion addition module adding the reconstructed motion vector components of the base layer, the first enhancement layer, and the at least one enhancement other than the first enhancement layer together and providing the motion vector.

14. The decoder of claim 12, wherein the motion vector reconstruction module comprises:
a first reconstruction module reconstructing a motion vector component of a first enhancement layer by attaching a sign to a value of the first enhancement layer contained in the motion information, which is opposite to a sign of a corresponding value of a base layer;
a second reconstruction module setting a motion vector component of a second enhancement layer to 0 when the value of the first enhancement layer is not 0 and reconstructing the motion vector component of the second enhancement layer from a value of the second enhancement layer contained in the motion information when the value of the first enhancement layer is 0;
a layer reconstruction module reconstructing a motion vector component of the base layer and a motion vector component of at least one enhancement layer other than the first and second enhancement layers from the corresponding value of the base layer and a value of the at least one enhancement layer other than the first and the second enhancement layers contained in the motion information, respectively; and
a motion addition module adding the reconstructed motion vector component of the base layer, the first enhancement layer, the second enhancement layer, and the at least one enhancement layer other than the first and the second enhancement layers together and providing the motion vector.

15. A method for reconstructing a motion vector obtained at predetermined pixel accuracy, the method comprising:
determining a motion vector component of a base layer using the obtained motion vector according to a pixel accuracy of the base layer; and
determining a motion vector component of an enhancement layer so that a sum of the motion vector component of the enhancement layer and the motion vector component of the base layer is close to the obtained motion vector according to a pixel accuracy of the enhancement layer.

16. The method of claim 15, wherein in the determining of the motion vector component of the base layer, the motion vector component of the base layer is determined to be close to a value predicted from motion vectors of neighboring blocks according to the pixel accuracy of the base layer.

17. The method of claim 15, wherein in the determining of the motion vector component of the base layer, the motion vector component of the base layer is determined according to the pixel accuracy of the base layer by separating the obtained motion vector into an original sign and a magnitude, using an unsigned value to represent the magnitude of the motion vector, and attaching the original sign to the unsigned value.

18. The method of claim 15, wherein in the determining of the motion vector component of the base layer, a value closest to the obtained motion vector is determined as the motion vector component of the base layer according to the pixel accuracy of the base layer.

19. A method for reconstructing a motion vector consisting of a base layer and at least one enhancement layer, the method comprising:
reconstructing a motion vector component of the base layer and a motion vector component of the at least one enhancement layer from a value of the base layer and a value of the at least one enhancement layer, respectively, the values of the base layer and the at least one enhancement layer being interpreted from an input bitstream; and
adding the reconstructed motion vector components of the base layer and the at least one enhancement layer together and providing the motion vector.

20. A method for reconstructing a motion vector consisting of a base layer and at least one enhancement layer, the method comprising:
reconstructing a motion vector component of a first enhancement layer by attaching a sign to a value of the first enhancement layer interpreted from an input bitstream, which is opposite to a sign of a corresponding value of the base layer;
reconstructing a motion vector component of the base layer and a motion vector component of an least one enhancement layer other than the first enhancement layer from the corresponding value of the base layer and a value of the at least one enhancement layer other than the first enhancement layer, respectively, the corresponding value of the base layer and the value of the at least one enhancement layer other than the first enhancement layer being interpreted from the input bitstream; and
adding the reconstructed motion vector components of the base layer, the first enhancement layer, and the at least one enhancement layer other than the first enhancement layer together and providing the motion vector.

21. A method for reconstructing a motion vector consisting of a base layer and at least one enhancement layer, the method comprising:
reconstructing a motion vector component of a first enhancement layer by attaching a sign to a value of the first enhancement layer interpreted from an input bitstream, which is opposite to a sign of a corresponding value of the base layer;
setting a motion vector component of a second enhancement layer to 0 when the value of the first enhancement layer is not 0 and reconstructing the motion vector component of the second enhancement layer from a value of the second enhancement layer interpreted from the input bitstream when the value of the first enhancement layer is 0;
reconstructing a motion vector component of the base layer and a motion vector component of at least one enhancement layer other than the first and the second enhancement layers from the corresponding value of the base layer and a value of the at least one enhancement layer other than the first and the second enhancement layers, respectively, the corresponding value of the base layer and the value of the at least one enhancement layer other than the first and the second enhancement layers being interpreted from the input bitstream; and
adding the reconstructed motion vector components of the base layer, the first enhancement layer, the second enhancement layer, and the at least one enhancement layer other than the first and the second enhancement layers together and providing the motion vector.
